(19) United States
(12) Patent Application Publication
(10) Pub. No.: US 2006/0155770 A1
(43) Pub. Date: Jul. 13, 2006

(54) System and method for time-based allocation of unique transaction identifiers in a multi-server system

(75) Inventors: Marc Asher, Highland Park, IL (US); James Kargman, Chicago, IL (US)

Correspondence Address: SCHIFF HARDIN, LLP;PATENT DEPARTMENT, 6600 SEARS TOWER, CHICAGO, IL, 60606-6473, US

(73) Assignee: IPDEV Co.

(21) Appl. No.: 11/369,254

(22) Filed: Mar. 7, 2006

Related U.S. Application Data
(63) Continuation-in-part of application No. 11/273,317, filed on Nov. 14, 2005.
(63) Continuation-in-part of application No. 11/177,674, filed on Jul. 8, 2005.
(60) Provisional application No. 60/627,083, filed on Nov. 11, 2004.
(60) Provisional application No. 60/627,083, filed on Nov. 11, 2004.

(51) Int. Cl. G06F 17/00; G06F 7/00

(52) U.S. Cl. 707/104.1

(57) ABSTRACT

A method and appertaining system are provided for creating and utilizing unique transaction identifiers for transactions within a service center comprising multiple processing hosts. A service center transaction number range based on a service center transaction handling capacity is established, and both first and second processing hosts each having their own transaction handling capacity are provided to the service center. A system-wide unique range of transaction sequence numbers are allocated to the first and second processing hosts that are respectively related to the handling capacity of each host. The hosts then use a time value combined with the unique range of identifiers for the transactions transmitted throughout the system.

### CROSS-REFERENCE TO RELATED APPLICATIONS

This application is a continuation-in-part of application Ser. No. 11/273,317, filed Nov. 14, 2005, and application Ser. No. 11/177,674, filed Jul. 8, 2005, both of which claim the benefit of provisional application Ser. No. 60/627,083, filed on Nov. 11, 2004, all of which are herein incorporated by reference.

### BACKGROUND

The invention relates to the field of transaction processing in a multi-server system and a time-based method for ensuring uniqueness of transaction identifiers.

Businesses that engage in electronic commerce make extensive use of databases for recording and processing transactions. The development of the Internet has permitted businesses to have widely dispersed operating sites and provided the means to communicate between these sites inexpensively and efficiently.

In multi-server systems that are designed to process numerous transactions originating from different servers, it is important that each of the transactions are identified uniquely both for processing and backup redundancy purposes so that the handling and archiving of the transactions occurs without error. This is particularly important in high-volume distributed applications that have a time-critical nature to the handling and processing of transactions.

It is known to include the use of a server or computer identifier as a part of the unique transaction identifier so that uniqueness of transactions across multiple originating computers/servers can be maintained.

### SUMMARY

The present invention is based on a system and method that is capable of uniquely identifying transactions in a multi-server or multi-computer system based on allocated ranges of sequence numbers.

According to various embodiments of the invention, a method is provided for creating and utilizing unique transaction identifiers for transactions within a service center comprising multiple processing hosts, the method comprising: establishing a service center transaction number range based on a service center transaction handling capability expressed in transactions per given unit of time; adding a first processing host having a first host transaction handling capacity to the service center; allocating a system-wide unique first range of transaction sequence numbers to the first added host that is a subset of the service center transaction number range; combining, by the first processing host, a time value and one of the allocated transaction sequence numbers for use as a unique transaction identifier; transmitting, from the first processing host, a transaction that includes the unique transaction identifier; adding a second processing host having a second host transaction handling capacity to the service center; allocating a system-wide unique second range of transaction sequence numbers to the second added host that is a subset of the service center transaction number range; combining, by the second processing host, a time value and one of the allocated transaction sequence numbers for use as a unique transaction identifier; and transmitting, from the second processing host, a transaction that includes the unique transaction identifier.

These embodiments may also include maintaining the allocated ranges of transaction sequence numbers in a sequence list database. Allocating the system-wide unique ranges of transaction sequence numbers may comprise initiating a request by the first or the second processing host to an allocation logic module for a range of sequence numbers that includes a number of transactions that can be handled in the given time unit; and transmitting, by the allocation logic module, the system-wide unique range of transaction sequence numbers that totals the number of transactions included in the request. The ranges may comprise numbers that are entirely contiguous or may include ranges that are represented by lists of contiguous or non-contiguous numbers. The method may also comprise initiation a notification or error handling procedure if one or more of the ranges are exceeded. The given unit of time may be one second or any other periodic time interval consistent with implementing the invention.

According to a further embodiment of the invention, a method is provided for creating and utilizing unique transaction identifiers for transactions in a transaction processing system comprising multiple service centers, the method comprising: establishing a transaction processing system transaction number range based on a transaction processing system transaction handling capability expressed in transactions per given unit of time; adding a first processing service center having a first service center transaction handling capacity to the transaction processing system; allocating a system-wide unique first range of transaction sequence numbers to the first added service center that is a subset of the transaction processing system transaction number range; utilizing, by the first service center, the allocated range of transaction sequence numbers to further allocate subsets of these sequence numbers to processing hosts within the first service center; adding a second service center having a second service center transaction handling capacity to the transaction processing system; allocating a system-wide unique second range of transaction sequence numbers to the second added service center that is a subset of the transaction processing system transaction number range; and utilizing, by the second service center, the allocated range of transaction sequence numbers to further allocate subsets of these sequence numbers to processing hosts within the second service center.

An appertaining system for creating and utilizing unique transaction identifiers for transactions within a service center comprising multiple processing hosts may be provided, comprising: a service center transaction number range store that holds a service center transaction number range based on a service center transaction handling capability expressed in transactions per given unit of time; a first processing host associated with the service center having a first host transaction handling capacity; software for allocating a system-wide unique first range of transaction sequence numbers to the first added host that is a subset of the service center transaction number range; software for combining, by the first processing host, a time value and one of the allocated transaction sequence numbers for use as a unique transaction identifier; a first communications connection via which a transaction that includes the unique transaction identifier is transmitted from the first processing host; a second processing host associated with the service center having a second host transaction handling capacity; software for allocating a system-wide unique second range of transaction sequence numbers to the second added host that is a subset of the service center transaction number range; software for combining, by the second processing host, a time value and one of the allocated transaction sequence numbers for use as a unique transaction identifier; and a second communications connection via which a transaction that includes the unique transaction identifier is transmitted from the second processing host.

### DESCRIPTION OF THE DRAWINGS

The invention is described below according to various preferred embodiments of the invention with reference to the following drawing figures.

FIG. 1 is a block diagram of an overall transaction processing system comprising multiple service centers;

FIG. 2 is a block diagram illustrating the service centers in greater detail;

FIG. 3A is a block diagram illustrating one of the service centers, including various constituent components;

FIG. 3B is a block diagram illustrating the communication server along with the host; and

FIG. 4 is a block diagram illustrating the transactions and their appertaining unique sequence numbers.

### DETAILED DESCRIPTION OF THE PREFERRED EMBODIMENTS

Exemplary embodiments of the invention are described below that relate to a high-volume, time-sensitive consumer-oriented distributed transaction processing system, such as the pizza ordering and delivery business.

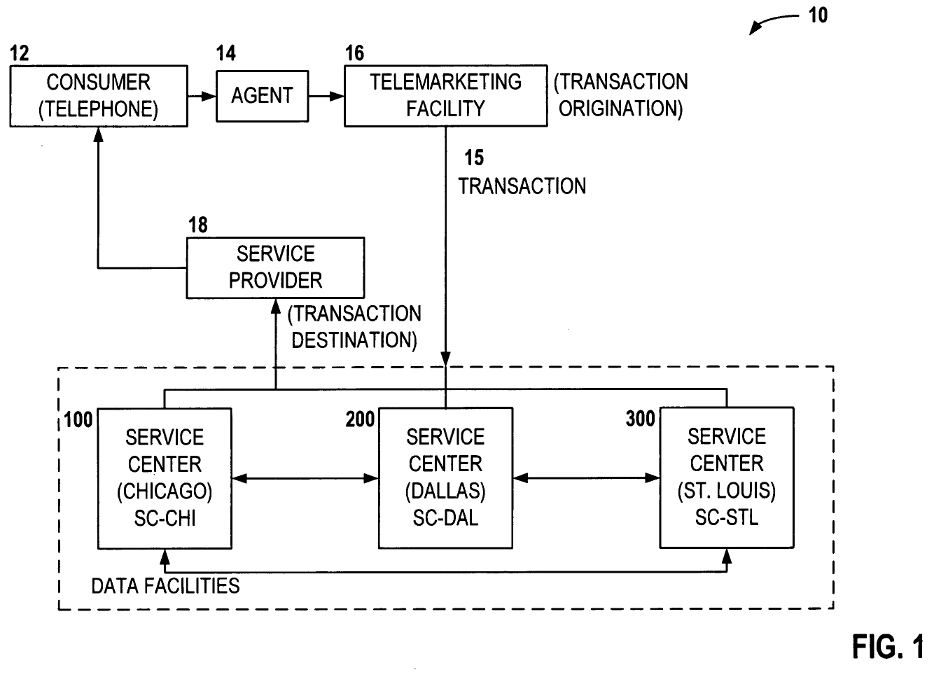

Such an embodiment of the system 10 is illustrated in FIG. 1, which provides a high-level overview. In this embodiment, a consumer/customer 12 wishes to order a pizza, and uses a telephone, computer, or portable electronic device to contact an agent 14 in order to provide the details of the order. The agent 14 may then contact a telemarketing facility 16 (which may be a real/physical facility, or a virtual facility that is not tied to any one location) that creates an originating transaction 15 based on the customer's order. The originating transaction 15 is sent to the service centers group 400, where it is allocated to one of a plurality of service centers 100, 200, 300. The agent 14 and telemarketing facility 16 can be located at any distance from either the consumer 12 or the service provider 18, and are used to facilitate the handling of the consumer's order.

Once the transaction is processed by one of the service centers in the group 400, the transaction is directed towards its ultimate destination, the service provider 18. In the pizza delivery business, the service provider 18 would likely be located in close proximity to the consumer 12 in order to timely deliver the pizza, although this is not necessarily the case in the event that a pizza was ordered by a first person for delivery to a second person at a different location. This constraint is further not necessary in situations where the service may be a computer-based service, such as a download of a software product. Note that status information can be sent to the service centers 100, 200, 300 from the service provider 18 related to order status, etc. This creates potential redundancy in the system in that if the consumer 12 is unable to contact the service provider 18, then additional information may be obtainable from the data facilities 100, 200, 300 regarding order status.

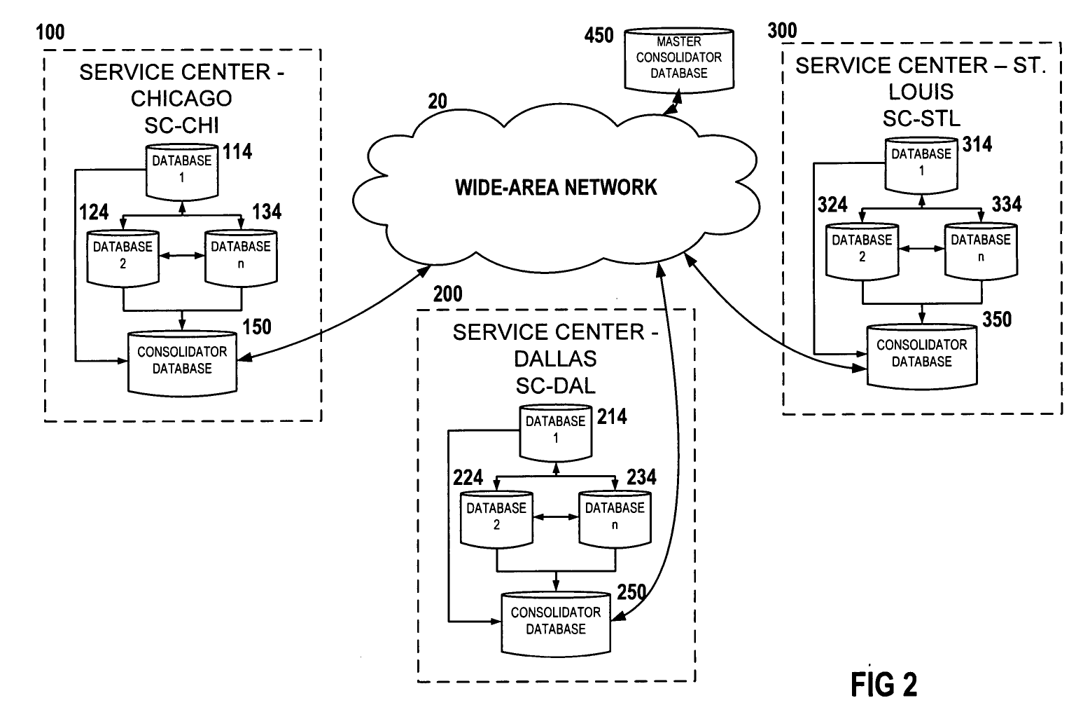

FIG. 2 illustrates the structure of the service centers 100, 200, 300 in more detail. As can be seen in FIG. 2, there are an exemplary three service centers associated with respective cities: a service center-Chicago 100 (SC-CHI), a service center-Dallas 200 (SC-DAL) and a service center-St. Louis 300 (SC-STL). The service centers are connected to a wide-area network 20, such as the Internet, via which the telemarketing facility 16 (or more broadly, a transaction originator), the service centers 100, 200, 300, and the service provider 18 communicate.

Each of the service centers 100, 200, 300, comprise one or more databases 114, 124, 134, 214, 224, 234, 314, 324, 334 in which local copies of transactions are maintained. The service centers 100, 200, 300 may also each comprise a consolidator database 150, 250, 350 into which all transactions of the appertaining service center databases are aggregated. The system may further comprise a master consolidator database 450 into which all system-wide transactions are aggregated.

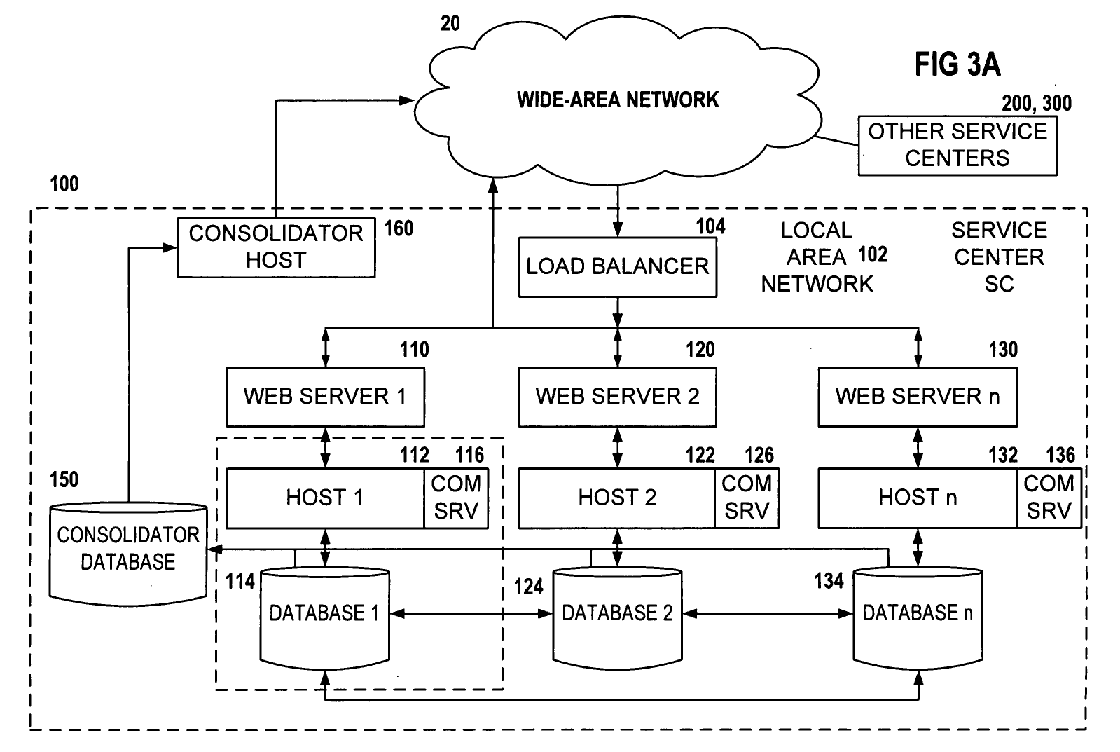

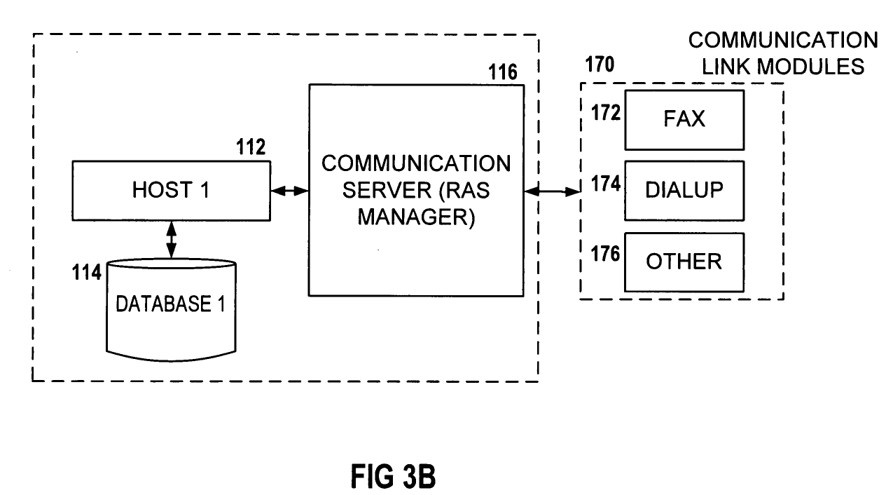

FIG. 3A illustrates an exemplary service center, SC-CHI 100 in more detail. The service center 100 comprises a load balancer 104 (e.g., an F5 load balancer or any other type of load balancer known in the industry) that receives transactions related to orders coming in over the wide-area network 20. The load balancer 104 balances the transaction load between the available systems 110, 120, 130 and creates a resulting very high up-time for the service center 100.

FIG. 3A illustrates a service center with three separate systems, although any number of systems, including a single system, may be used. An example of a system comprises a web server 110, a host computer 112, and a transaction database 114, along with a communication server 116. It may be possible to combine the host (aka “database server”) 112, database 114 and/or communication server 116 onto a single system. The load balancer 104 is designed to allocate transactions based on the load handling capabilities of the systems, and can allocate around any systems that are down.

The system is designed so that transactions stored on one database 114 are cross-journaled into the others 123, 134 that are available. This provides a necessary level of redundancy so that transactions are not lost in the event that one of the systems 110, 112, 114, 116 crash. The transactions may also be cross-journaled into a consolidator database 150 using shadow server journaling—this database 150 only journals unique transaction entries to avoid unnecessary replication.

Unique transactions are communicated from the service center 100 to other service centers 200, 300 over the wide-area network 20 via a consolidator host 160 according to a scheduled procedure according to business rules. The consolidator host 160 may perform a variety of functions, including compressing the data and transmitting data using, e.g., FTP, etc.

FIG. 3B illustrates the communication server 116 and its association with communication link modules 179, that can include FAX 172, dialup 174 and other physical level communication elements 176. The communication server 116 processes a queue and is independent of the mechanism via which queued elements must be sent—the communication link modules 170 handle the details associated with a particular type of communication. Although it appears that there is a one-to-one pairing of the communication server 116, communication link modules 170, and host 112, such a configuration is not necessary. Multiple hosts can share a single communication server 116, and a single communication link module 170 can service multiple communication servers 116, or vise versa (i.e., there can be a many-to-many relationship between these entities).

Since the transactions within the transaction processing system 10 must be identified using unique transaction identifiers in the event that one system crashes and the transaction database be reconstructed, the following discussion relates to the creation of system-wide unique time-based transaction identifiers.

For the sake of simplicity, a single service center 100 system will be described, and then, following this is a description of the adaptations necessary for a multiple service center 400 system.

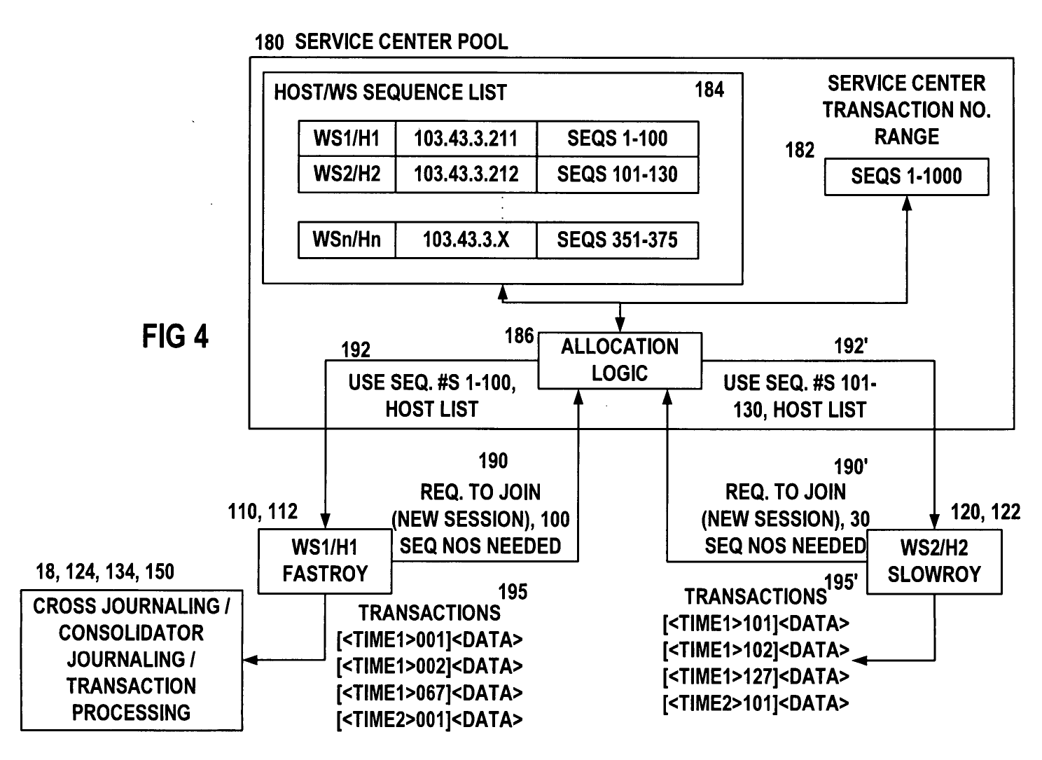

As illustrated in FIG. 4, the transaction records 195, 195′ are broadly broken down into a time-based transaction identifier and transaction data. The transaction identifier comprises a time component <TIME> and a sequence number (e.g., “001”). The time component has some particular level of granularity that represents the minimum representable time difference that can be captured. This granularity could be any arbitrary unit of time: hours, minutes, seconds, days, fortnights, etc. However, for the following discussion and according to a preferred embodiment of the invention, the granularity will be presumed to be one second. It should be noted that the transaction identifier does not require a system ID, i.e., an identifier that uniquely identifies the computer system itself, within the identifier.

In such a scheme, the time could be represented in, e.g., an ASCII format, such as “MM/DD/YYYY HH:MM:SS”, or it could be represented as an integer value denoting the number of seconds elapsed since some absolute system-wide reference point, such as that used in UNIX-based systems relating to the first instant of Jan. 1, 2001 (see NSDate and related functions). It is not particularly important as to how the time is represented, although time formats that use less memory and are integer-based are advantageous because they can be processed more quickly.

Following the time is a repeating sequence number. As can be seen in the transactions 195 associated with the first host/workstation FASTROY 110, 112, transaction sequence no. 001 repeats at TIME2. Similarly, for the transactions 195′ associated with the second host/workstation SLOWROY 120, 122, transaction sequence no. 101 repeats at TIME2.

The ability to maintain a unique transaction identifier based on the combination of time and sequence number requires that a unique range of sequence numbers be allocated to each of the systems 110, 120 (or 112, 122). This can be achieved as follows.

A service center 100 can be defined as being able to process some maximum number of transactions within a given period of time defined by the time granularity of the system. In the present example, this would be the maximum number of transaction that can be handled per second, and could be determined empirically or determined based on calculations related to the processing capability of all known or planned systems 110, 112, 120, 122 within the service center 100. For exemplary purposes, the service center 100 is determined to be able to handle 1000 transactions per second.

This means that the service center 100 can utilize a range of 1000 sequence numbers without running out in one second before starting over with the transaction sequence numbers. The range of sequence numbers for the service center 100 can be stored in a service center transaction number range buffer 182. As illustrated, the service center has sequence numbers 1-1000 allocated to it, but this range could be 1001-2000, 5001-6000, etc. Furthermore, this range can be manually entered or it can be assigned based on information and/or logic outside of the service center 100, but associated with the entire system 10.

When a new workstation/host 110, 112 joins the service center 100, a determination is made of its capability to handle transactions. Its transaction handling capabilities can be predetermined prior to joining or possibly determined empirically or automatically by elements of the service center or other diagnostic equipment. In the example shown in FIG. 4, FASTROY 110, 112 is determined to be capable of processing 100 transactions per second, and therefore needs a range of 100 sequence numbers allocated to it. FASTROY 110, 112 sends a request to join 190 to allocation logic 186 associated with the service center 100. The allocation logic looks to both the host/workstation sequence list 184 and the service center transaction number range 182 to determine the next available list of 100 sequence numbers to assign to FASTROY 110, 112. Since this is the first host/workstation to join, the allocation logic allocates sequence numbers 1-100 for FASTROY 110, 112 to use, records this allocation in the host/workstation sequence list 184, and then sends a message 192 to FASTROY 110, 112 providing the sequence numbers available to it.

In the event that a range of sequence numbers are not available, the allocation logic 186 could provide an error message to a user display, log file, etc. Similarly, in the event that a workstation/host 110, 112 exceeds the number of transactions in a second originally granted to it, then an error message could also be generated, and the parameters updated.

It should be noted that the allocation of sequence numbers should generally not be done simply because a workstation/host 110, 112 is temporarily down—such reallocations would generally be performed about reorganizing events such as the addition of a workstation/host 110, 112 to the service center 100 or the permanent removal of a workstation/host 110, 112 to the service center 100.

Once the workstation/host 110, 112 has its range of sequence numbers allocated to it, it can begin processing transactions 195 and forwarding them on for cross journaling, consolidator journaling, transaction processing, etc.

Continuing with the above example, when workstation/host SLOWROY 120, 122 is added to the system, it requests to join 190′ the service center and indicates that it can handle 30 transactions per second and therefore needs a range of 30 transaction sequence numbers to use. The allocation logic looks to the sequence list 184 and determines that since sequence numbers 1-100 are already in use by FASTROY 110, 112, it will grant SLOWROY the next available 30 sequence numbers 101-130, and performs the same reservation of sequence numbers in the sequence list 184 and communication 192′ to the workstation SLOWROY 120, 122 of its range of sequence numbers available.

In this manner, provided no overflow or other errors occur, it can be guaranteed that the transaction identifiers will be unique within the service center 100 when cross journaling, consolidator journaling, or other types of transaction handling.

Generalizing now to the multi-service center system 10, the sequence number allocations are performed in essentially the same way except one level higher. The overall system 10 has some predetermined maximum transaction handling capability-say, for example, 10,000 transactions per second. The transaction processing rate for each of the service centers 100, 200, 300 is either empirically determined or calculated based on known or planned architectures. The system 10 then allocates sequence number ranges to the service centers 100, 200, 300 in a similar manner as the service center 100 allocated the sequence numbers to the workstation/hosts. 110, 112, 120, 122.

So, for example, the Chicago service center 100 is capable of handling 1000 transactions per second, so it is allocated sequence numbers 1-1000. The Dallas service center 200 can handle 5000 transactions per second, so it is allocated sequence numbers 1001-6000, and the St. Louis service center 300 can handle 500 transactions per second, so it is allocated sequence numbers 6001-6500.

A service center 100 can be reconfigured without disrupting the sequence number allocations for other service centers 200, 300 as long as the reconfiguration of the service center 100 does not result in exceeding the transaction range 182 allocated to the service center 100. However, if the service center 100 reconfiguration results in requiring additional sequence numbers, then a system-wide reallocation of sequence numbers may be required.

Although it is possible to construe the term “range” as requiring a contiguous sequence of numbers, as used herein, a “range” can comprise any number of disjointed ranges or lists of numbers. One of ordinary skill in the art would recognize that various forms of allocations such as tables, etc. could be used. For example, FASTROY could be allocated sequence numbers 002, 004, 007, 011, and SLOWROY could be allocated sequence numbers 001, 003, 005, 006. It is not important that the allocated numbers be contiguous—only that they be unique for a particular system. While this latter scheme would be more complex than the use of simple contiguously sequential number ranges, it could permit, e.g., a service center 100 to have its overall range increased without impacting the remaining service centers 200, 300. In the example above, if later it was decided that the Chicago service center can handle 2000 transactions per second, it could be allocated sequence numbers 1-1000 and 6501-7500 without impacting the allocation of sequence numbers from the other service centers 200, 300.

In this way, uniquely defined sequence numbers can be used that include the time and an allocated sequence number range that does not-require the inclusion of a system id.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### TABLE OF REFERENCE CHARACTERS

10 transaction processing system
12 consumer/customer
14 agent
15 originating transaction
16 telemarketing facility
18 service provider
100, 200, service center
300
102 local area network
104 load balancer
110, 120, web server
130
112, 122, host
132
114, 124, transaction database
134
116, 126, communication servers
136
150, 250, service center consolidator database
160 consolidator host
170 communication link modules
172 FAX
174 dial-up
176 other communication link modules
180 service center pool
182 service center transaction number range buffer
184 host/workstation sequence list
186 sequence number allocation logic
190 request to join service center
192 sequence number range
195, 195′ transactions
400 service centers group
450 master consolidator database

What is claimed is:

1. A method for creating and utilizing unique transaction identifiers for transactions within a service center comprising multiple processing hosts, the method comprising:
establishing a service center transaction number range based on a service center transaction handling capability expressed in transactions per given unit of time;
adding a first processing host having a first host transaction handling capacity to the service center;
allocating a system-wide unique first range of transaction sequence numbers to the first added host that is a subset of the service center transaction number range;
combining, by the first processing host, a time value and one of the allocated transaction sequence numbers for use as a unique transaction identifier;
transmitting, from the first processing host, a transaction that includes the unique transaction identifier;
adding a second processing host having a second host transaction handling capacity to the service center;
allocating a system-wide unique second range of transaction sequence numbers to the second added host that is a subset of the service center transaction number range;
combining, by the second processing host, a time value and one of the allocated transaction sequence numbers for use as a unique transaction identifier; and
transmitting, from the second processing host, a transaction that includes the unique transaction identifier.

2. The method according to claim 1, further comprising:
maintaining the allocated ranges of transaction sequence numbers in a sequence list database.

3. The method according to claim 1, wherein allocating the system-wide unique ranges of transaction sequence numbers comprises:
initiating a request by the first or the second processing host to an allocation logic module for a range of sequence numbers that includes a number of transactions that can be handled in the given time unit; and
transmitting, by the allocation logic module, the system-wide unique range of transaction sequence numbers that totals the number of transactions included in the request.

4. The method according to claim 1, wherein the ranges comprise numbers that are entirely contiguous.

5. The method according to claim 1, wherein the ranges are represented by lists of contiguous or non-contiguous numbers.

6. The method according to claim 1, further comprising:
initiating a notification or error handling procedure if one or more of the ranges are exceeded.

7. The method according to claim 1, wherein the given unit of time is one second.

8. A method for creating and utilizing unique transaction identifiers for transactions in a transaction processing system comprising multiple service centers, the method comprising:
establishing a transaction processing system transaction number range based on a transaction processing system transaction handling capability expressed in transactions per given unit of time;
adding a first processing service center having a first service center transaction handling capacity to the transaction processing system;
allocating a system-wide unique first range of transaction sequence numbers to the first added service center that is a subset of the transaction processing system transaction number range;
utilizing, by the first service center, the allocated range of transaction sequence numbers to further allocate subsets of these sequence numbers to processing hosts within the first service center;
adding a second service center having a second service center transaction handling capacity to the transaction processing system;
allocating a system-wide unique second range of transaction sequence numbers to the second added service center that is a subset of the transaction processing system transaction number range; and
utilizing, by the second service center, the allocated range of transaction sequence numbers to further allocate subsets of these sequence numbers to processing hosts within the second service center.

9. The method according to claim 8, wherein the ranges comprise numbers that are entirely contiguous.

10. The method according to claim 8, wherein the ranges are represented by lists of contiguous or non-contiguous numbers.

11. The method according to claim 8, further comprising:
initiating a notification or error handling procedure if one or more of the ranges are exceeded.

12. The method according to claim 8, wherein the given unit of time is one second.

13. A system for creating and utilizing unique transaction identifiers for transactions within a service center comprising multiple processing hosts, comprising:
a service center transaction number range store that holds a service center transaction number range based on a service center transaction handling capability expressed in transactions per given unit of time;
a first processing host associated with the service center having a first host transaction handling capacity;
software for allocating a system-wide unique first range of transaction sequence numbers to the first added host that is a subset of the service center transaction number range;
software for combining, by the first processing host, a time value and one of the allocated transaction sequence numbers for use as a unique transaction identifier;
a first communications connection via which a transaction that includes the unique transaction identifier is transmitted from the first processing host;
a second processing host associated with the service center having a second host transaction handling capacity;
software for allocating a system-wide unique second range of transaction sequence numbers to the second added host that is a subset of the service center transaction number range;
software for combining, by the second processing host, a time value and one of the allocated transaction sequence numbers for use as a unique transaction identifier; and
a second communications connection via which a transaction that includes the unique transaction identifier is transmitted from the second processing host.
